(19) United States
(12) Patent Application Publication
(10) Pub. No.: US 2023/0414040 A1
(43) Pub. Date: Dec. 28, 2023

(54) Infant Bottle-Preparing Device

(71) Applicant: Octavious Rackard, Fellsmere, FL (US)

(72) Inventor: Octavious Rackard, Fellsmere, FL (US)

(21) Appl. No.: 18/340,915

(22) Filed: Jun. 26, 2023

Related U.S. Application Data
(60) Provisional application No. 63/355,113, filed on Jun. 24, 2022.

(51) Int. Cl. A47J 43/07; A47J 36/24; A47J 43/042

(52) U.S. Cl. CPC A47J 43/07; A47J 36/2411; A47J 43/042

(57) ABSTRACT

An infant bottle-preparing device is provided. The device is comprised of a body comprised of at least one water container, at least one formula container, at least one mixing structure, at least one warming structure, at least one pump, and at least one motor. During use, the design allows a user to prepare an infant's bottle by heating and mixing formula powder and water stored on the device from within the device, wherein said mixture is then dispensed to an attached infant bottle which can be removed for feeding.

### CROSS-REFERENCE TO RELATED APPLICATION

The present application claims priority to, and the benefit of, U.S. Provisional Application No. 63/355,113, which was filed on Jun. 24, 2022, and is incorporated herein by reference in its entirety.

### FIELD OF THE INVENTION

The present invention relates generally to the field of infant bottle-mixing devices. More specifically, the present invention relates to an infant bottle-preparing device that allows a user to easily and quickly prepare an infant's bottle using bottle formula powder and water without spillage. Accordingly, the present disclosure makes specific reference thereto. Nonetheless, it is to be appreciated that aspects of the present invention are also equally applicable to other like applications, devices, and methods of manufacture.

### BACKGROUND

Preparing an infant's bottle can be a messy experience, with spills occurring often during the formula powder transferring, water measurement, and mixing process. Parents may also spend a considerable amount of time preparing the bottle only to leave the child upset and anxious while waiting.

Therefore, there exists a long-felt need in the art for a device that improves the infant bottle-making process. There also exists a long-felt need in the art for an infant bottle-preparing device that allows a user to quickly prepare an infant's bottle. Further, there exists a long-felt need in the art for an infant bottle-preparing device that allows a user to quickly prepare an infant's bottle while eliminating the chance of spillage of water or powder formula.

The subject matter disclosed and claimed herein, in one embodiment thereof, comprises an infant bottle-preparing device. The device is comprised of a body comprised of at least one water container, at least one formula container, at least one mixing structure, at least one warming structure, at least one pump, and at least one motor. The device is designed to be used to prepare an infant's bottle by heating and mixing formula powder and water stored therein from within the device, wherein said mixture is then dispensed to an attached infant bottle which can be removed for feeding.

In this manner, the infant bottle-preparing device of the present invention accomplishes all the foregoing objectives and provides a device that improves the infant bottle-making process. During use, the device allows a user to quickly prepare an infant's bottle. While doing so, the device eliminates the chance of spillage of water or powder formula.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an infant bottle-preparing device primarily comprised of a body comprised of at least one water container, at least one formula container, at least one mixing structure, at least one warming structure, at least one pump, and at least one motor. The device is designed to be used to prepare an infant's bottle by heating and mixing formula powder and water stored on the device.

To do so, the body of the device is comprised of at least one water container and at least one formula container. The water container is in fluid communication with at least one warming structure of the device. Water can be poured into the container (and stored until needed) via a first opening. The water can then be secured within the container via at least one cap. Similarly, the formula container is in fluid communication with at least one mixing structure of the device via at least one second opening. Formula powder can be poured into the container (and stored until needed) via a first opening. The powder can then be secured within the container via at least one cap.

The body is also comprised of at least one handle. The handle is comprised of at least one trigger. When pulled, the trigger begins the bottle-making process of the device. However, before pulling the trigger, a user can use at least one interface to select a plurality of parameters pertaining to the bottle the device will prepare out of the water and formula powder within the containers. For example, the interface allows a user to select how much water is to be used for the bottle (i.e., 4 oz., 6 oz., 8 oz.) and allows a user to internally clean the mixing structure using leftover water from the container after a bottle has been made/mixed using the device.

Once a water amount is selected and the trigger is pulled, at least one pump moves said pre-select quantity of water from the container into the warming structure. Once the water has reached a desired temperature in the warming structure, the heated water is transferred to the mixing structure. Then, at least one door of the formula container is opened via at least one motor such that a specific amount of formula powder is dropped into the mixing structure. Once the door closes, the formula powder and heated water are mixed for a period of time until a uniform consistency is reached. Then a door of the body below the mixing structure opens via the motor to allow the mixture to be transferred via the pump into an infant bottle, which has at least one threaded opening, that is attached to the body via at least one threaded bottle opening. After the mixing structure has been emptied, the door then closes via the motor and the bottle can be removed, such that a user can screw a threaded cap onto the bottle and serve the bottle to an infant for feeding.

The present invention is also comprised of a method of using the device. First, a device is provided comprised of a body comprised of a handle with a trigger, an interface, a mixing structure, a warming structure, a pump, a battery, a water container, and a formula container. Next, a user can remove a cap from an infant bottle and secure the bottle within a bottle opening of the body. Then, a user uses the interface to select the amount of and heating temperature of the water that is dispensed to the warming structure by pulling the trigger. After the water from the water container has been heated and mixed with the powder formula from the formula container in the mixing structure and dispensed into the bottle, a user can remove the bottle from the bottle opening. Then, the user can reattach the cap to the bottle and serve the bottle mixture to an infant.

The present invention is also comprised of a second method of using the device. First, a device is provided comprised of a body comprised of a handle with a trigger, an interface, a mixing structure, a warming structure, a pump, a battery, a water container, and a formula container. Next, a user can remove a cap from an infant bottle and secure the bottle within a bottle opening of the body. Then, a user uses the interface to select the amount of and heating temperature of the water that is dispensed to the warming structure by pulling the trigger. After the water from the water container has been heated and mixed with the powder formula from the formula container in the mixing structure and dispensed into the bottle, a user can remove the bottle from the bottle opening. Then, the user can reattach the cap to the bottle and serve the bottle mixture to an infant. To clean the internal components of the device, a user can also select a cleaning cycle setting on the interface and pull the trigger again to dispense water from the water container through the device.

Accordingly, the infant bottle-preparing device of the present invention is particularly advantageous as it provides a device that improves the infant bottle-making process. During use, the device allows a user to quickly prepare an infant's bottle. While doing so, the device eliminates the chance of spillage of water or powder formula. In this manner, the infant bottle-preparing device overcomes the limitations of existing methods of making an infant's bottle known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a side view of one potential embodiment of an infant bottle-preparing device of the present invention in accordance with the disclosed architecture;

FIG. 2 illustrates an enhanced perspective view of one potential embodiment of an infant bottle-preparing device of the present invention in accordance with the disclosed architecture;

FIG. 3 illustrates an enhanced rear perspective view of one potential embodiment of an infant bottle-preparing device of the present invention in accordance with the disclosed architecture;

FIG. 4 illustrates a side view of one potential embodiment of an infant bottle-preparing device of the present invention with the bottle unattached in accordance with the disclosed architecture;

FIG. 5 illustrates a flowchart of a method of using one potential embodiment of an infant bottle-preparing device of the present invention in accordance with the disclosed architecture; and

FIG. 6 illustrates a flowchart of a method of using one potential embodiment of an infant bottle-preparing device of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a device that improves the infant bottle-making process. There also exists a long-felt need in the art for an infant bottle-preparing device that allows a user to quickly prepare an infant's bottle. Further, there exists a long-felt need in the art for an infant bottle-preparing device that allows a user to quickly prepare an infant's bottle while eliminating the chance of spillage of water or powder formula.

The present invention, in one exemplary embodiment, is comprised of an infant bottle-preparing device. The device is primarily comprised of a body comprised of at least one water container, at least one formula container, at least one mixing structure, at least one warming structure, at least one pump, and at least one motor. The device is designed to be used to prepare an infant's bottle by heating and mixing formula powder and water stored on the device.

The body is comprised of at least one water container and at least one formula container. The water container is in fluid communication with at least one warming structure of the device. Water can be poured into the container (and stored until needed) via a first opening and can then be secured within the container via at least one cap. Similarly, the formula container is in fluid communication with at least one mixing structure of the device via at least one second opening. Formula powder can be poured into the container (and stored until needed) via a first opening. The powder can then be secured within the container via at least one cap.

The body is also comprised of at least one handle. The handle is comprised of at least one trigger. When pulled, the trigger begins the bottle-making process of the device. However, before pulling the trigger, a user can use at least one interface to select a plurality of parameters pertaining to the bottle the device will prepare out of the water and formula powder within the containers. For example, the interface allows a user to select how much water is to be used for the bottle (i.e., 4 oz., 6 oz., 8 oz.) and allows a user to internally clean the mixing structure using leftover water from the container after a bottle has been made/mixed using the device.

Once a water amount is selected and the trigger is pulled, at least one pump moves said pre-select quantity of water from the container into the warming structure. Then, once the water has reached a desired temperature in the warming structure, the heated water is transferred to the mixing structure. Next, at least one door of the formula container is opened via at least one motor such that a specific amount of formula powder is dropped into the mixing structure. Once the door closes, the formula powder and heated water are mixed for a period of time until a uniform consistency is reached. Then a door of the body below the mixing structure opens via the motor to allow the mixture to be transferred via the pump into an infant bottle, which has at least one threaded opening that is attached to the body via at least one threaded bottle opening. After the mixing structure has been emptied, the door then closes via the motor and the bottle can be removed, such that a user can screw a threaded cap onto the bottle and serve the bottle to an infant for feeding.

The present invention is also comprised of a method of using the device. First, a device is provided comprised of a body comprised of a handle with a trigger, an interface, a mixing structure, a warming structure, a pump, a battery, a water container, and a formula container. Next, a user can remove a cap from an infant bottle and secure the bottle within a bottle opening of the body. Then, a user uses the interface to select the amount of and heating temperature of the water that is dispensed to and heated by the warming structure by pulling the trigger. After the water from the water container has been heated and mixed with the powder formula from the formula container in the mixing structure and dispensed into the bottle, a user can remove the bottle from the bottle opening. Then, the user can reattach the cap to the bottle and serve the bottle mixture to an infant.

The present invention is also comprised of a second method of using the device. First, a device is provided comprised of a body comprised of a handle with a trigger, an interface, a mixing structure, a warming structure, a pump, a battery, a water container, and a formula container. Next, a user can remove a cap from an infant bottle and secure the bottle within a bottle opening of the body. Then, a user uses the interface to select the amount of and heating temperature of the water that is dispensed to and heated by the warming structure by pulling the trigger. After the water from the water container has been heated and mixed with the powder formula from the formula container in the mixing structure and dispensed into the bottle, a user can remove the bottle from the bottle opening. Then, the user can reattach the cap to the bottle and serve the bottle mixture to an infant. To clean the internal components of the device, a user can also select a cleaning cycle setting on the interface and pull the trigger again to dispense water from the water container through the device.

Accordingly, the infant bottle-preparing device of the present invention is particularly advantageous as it provides a device that improves the infant bottle-making process. During use, the device allows a user to quickly prepare an infant's bottle. While doing so, the device eliminates the chance of spillage of water or powder formula. In this manner, the infant bottle-preparing device overcomes the limitations of existing methods of making an infant's bottle known in the art.

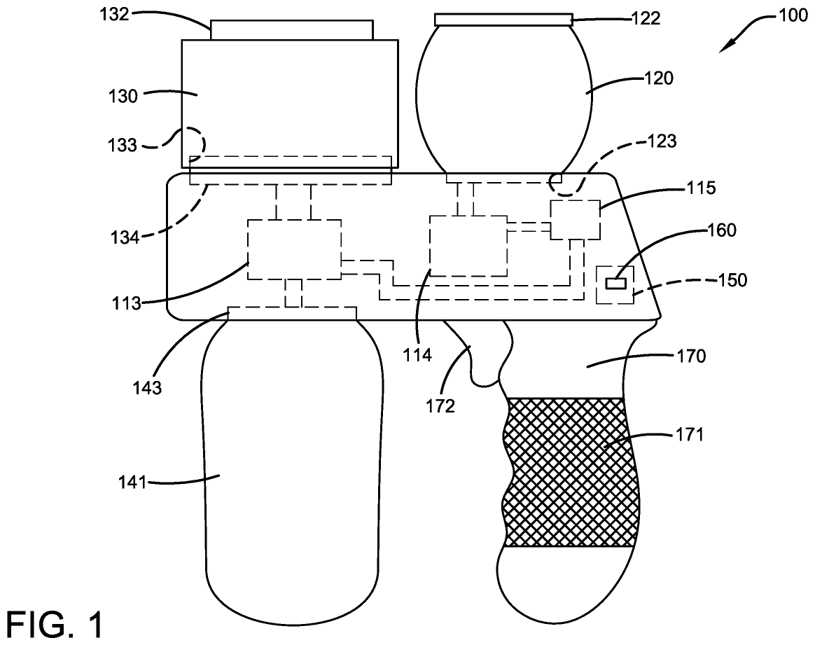

Referring initially to the drawings, FIG. 1 illustrates a side view of one potential embodiment of an infant bottle-preparing device 100 of the present invention in accordance with the disclosed architecture. The device is primarily comprised of a body 110 comprised of at least one water container 120, at least one formula container 130, at least one mixing structure 113, at least one warming structure 114, at least one pump 115, and at least one motor 180. The device 100 is designed to be used to prepare an infant's bottle by heating and mixing formula powder and water stored on the device 100.

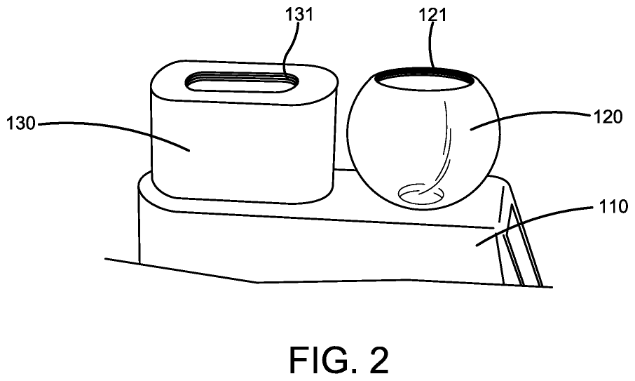

To do so, the body 110 of the device 100 is comprised of at least one water container 120 and at least one formula container 130, as seen in FIG. 2 (while opened). The water container 120 is in fluid communication with at least one warming structure 114 of the device 100 via at least one second opening 123. Water can be poured into the container 120 (and stored until needed) via a first opening 121. The water can then be secured within the container 120 via at least one cap 122. The cap 122 and opening 121 are preferably threaded such that the cap 122 is removably secured over the opening 122. The water container 120 is preferably fixedly attached to the body 110 but may be removably attached in one embodiment. The warming structure 114 may be any type known in the art.

Similarly, the formula container 130 is in fluid communication with at least one mixing structure 113 of the device 100 via at least one second opening 133. Formula powder can be poured into the container 130 (and stored until needed) via a first opening 131. The powder can then be secured within the container 130 via at least one cap 132. The cap 132 and opening 131 are preferably threaded such that the cap 132 is removably secured over the opening 132. The formula container 130 is preferably fixedly attached to the body 110 but may be removably attached in one embodiment.

The body 110 is also comprised of at least one handle 170. The handle 170 may be comprised of at least one grip area 171 made from a textured (i.e., raised or recessed) or non-textured non-slip material such as, but not limited to, rubber that aids a user in gripping the handle 170. The handle 170 is comprised of at least one trigger 172 that when pulled, begins the bottle-making process of the device 100. In one embodiment, the handle 170 is contoured to receive the fingers of a user.

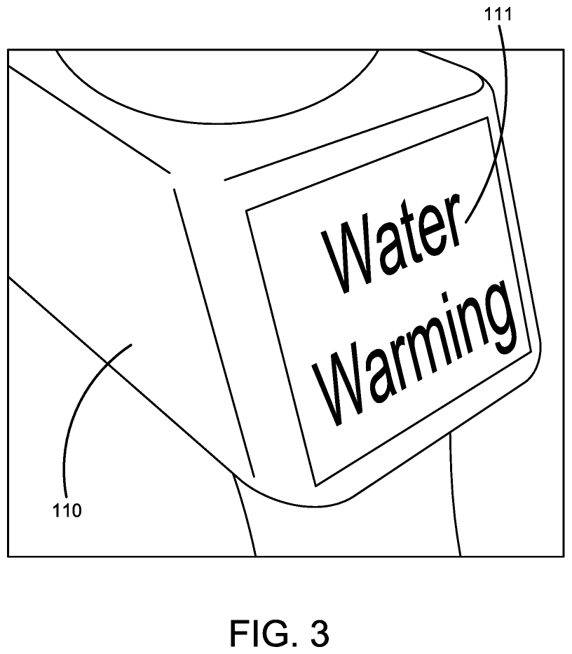

Before pulling the trigger 172, a user can use at least one interface 111 (as seen in FIG. 3) to select a plurality of parameters pertaining to the bottle the device 100 will prepare out of the water and formula powder within the containers 120,130. The interface 111 may be a touch screen or at least one physical button in different embodiments. The interface 111 allows a user to select how much water is to be used for the bottle (i.e., 4 oz., 6 oz., 8 oz.) and allows a user to internally clean the mixing structure 113 using leftover water from the container 120 after a bottle has been made/mixed using the device 100.

Once a water amount is selected and the trigger 172 is pulled, at least one pump 115 moves said pre-select quantity of water from the container 120 and into the warming structure 114. In one embodiment, a user can use the interface 111 to select a specific temperature the warming structure 114 heats the water to. The warming structure 114 may be any liquid warming structure known in the art such as, but not limited to, electric heating coils.

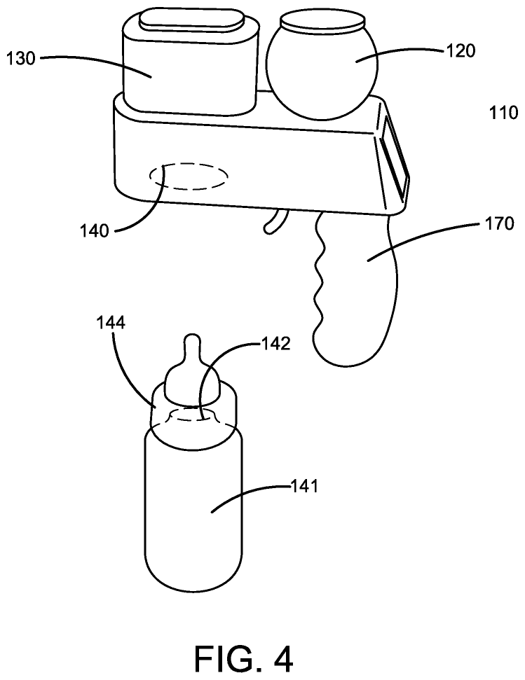

Once the water has reached the desired temperature in the warming structure, the heated water is transferred to the mixing structure 113. Then, at least one door 134 of the formula container 130 is opened via at least one motor 180 such that a specific amount of formula powder is dropped into the mixing structure 113. Once the door closes 134, the formula powder and heated water are mixed for a period of time until a uniform consistency is reached. Then a door 143 of the body 110 below the mixing structure 113 opens via the motor 180 to allow the mixture to be transferred via the pump 115 into an infant bottle 141, which has at least one threaded opening 142 that is attached to the body 110 via at least one threaded bottle opening 140. After the mixing structure 113 has been emptied, the door 143 then closes via the motor 115 and the bottle 141 can be removed, such that a user can screw a threaded cap 144 onto the bottle 141 (as seen in FIG. 4) and serve the bottle 141 to an infant for feeding.

A user can then use the interface 111 to select a cleaning cycle, wherein a quantity of water is pumped via the pump 115 from the container 120 through both structures 113,114, and out the door 143 of the body 110 to clean the device internally. The cycle preferably begins after it has been selected on the interface 111 and the user pulls the trigger 172.

The mixing structure 113, warming structure 114, pump 115, and motor 180 are powered by at least one battery within the body 110. In one embodiment, the battery 150 is a disposable battery. In another embodiment, the battery 150 is rechargeable via at least one charging port 160 on the body 110, such as, but not limited to, a USB port.

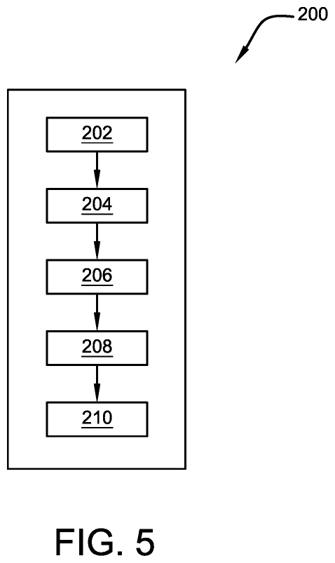

The present invention is also comprised of a method of using 200 the device 100, as seen in FIG. 5. First, a device 100 is provided comprised of a body 110 comprised of a handle 170 with a trigger 172, an interface 111, a mixing structure 113, a warming structure 114, a pump 115, a battery 150, a water container 120, and a formula container 130 [Step 202]. Next, a user can remove a cap 144 from an infant bottle 141 and secure the bottle 141 within a bottle opening 140 of the body 110 [Step 204]. Then, a user uses the interface 111 to select the amount of and heating temperature of the water that is dispensed to and heated by the warming structure 114 by pulling the trigger 172 [Step 206]. After the water from the water container 120 has been heated and mixed with the powder formula from the formula container 130 in the mixing structure 113 and dispensed into the bottle 141, a user can remove the bottle 141 from the bottle opening 140 [Step 208]. Then, the user can attach the cap 144 to the bottle 141 and serve the bottle mixture to an infant [step 210].

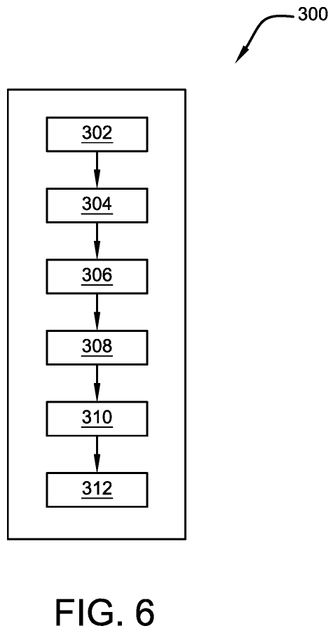

The present invention is also comprised of a second method of using 300 the device 100, as seen in FIG. 6. First, a device 100 is provided comprised of a body 110 comprised of a handle 170 with a trigger 172, an interface 111, a mixing structure 113, a warming structure 114, a pump 115, a battery 150, a water container 120, and a formula container 130 [Step 302]. Next, a user can remove a cap 144 from an infant bottle 141 and secure the bottle 141 within a bottle opening 140 of the body 110 [Step 304]. Then, a user uses the interface 111 to select the amount of and heating temperature of the water that is dispensed to and heated by the warming structure 114 by pulling the trigger 172 [Step 306]. After the water from the water container 120 has been heated and mixed with the powder formula from the formula container 130 in the mixing structure 113 and dispensed into the bottle 141, a user can remove the bottle 141 from the bottle opening 140 [Step 308]. Then, the user can attach the cap 144 to the bottle 141 and serve the bottle mixture to an infant [step 310]. To clean the internal components of the device 100, a user can also select a cleaning cycle setting on the interface 111 and pull the trigger 172 again to dispense water from the water container 120 through the device 100 [Step 312].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “infant bottle-preparing device” and “device” are interchangeable and refer to the infant bottle-preparing device 100 of the present invention.

Notwithstanding the foregoing, the infant bottle-preparing device 100 of the present invention and its various components can be of any suitable size and configuration as is known in the art without affecting the overall concept of the invention, provided that they accomplish the above-stated objectives. One of ordinary skill in the art will appreciate that the size, configuration, and material of the infant bottle-preparing device 100 as shown in the FIGS. are for illustrative purposes only, and that many other sizes and shapes of the infant bottle-preparing device 100 are well within the scope of the present disclosure. Although the dimensions of the infant bottle-preparing device 100 are important design parameters for user convenience, the infant bottle-preparing device 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An infant bottle-preparing device comprising:
a first container comprised of a first cap;
a second container comprised of a second cap;
a mixing structure;
a warming structure;
a pump;
a motor;
a battery;
a threaded opening;
a trigger; and
a touchscreen.

2. The infant bottle-preparing device of claim 1, wherein the first container is in fluid communication with the mixing structure.

3. The infant bottle-preparing device of claim 2, wherein the mixing structure is in fluid communication with the warming structure.

4. The infant bottle-preparing device of claim 1, wherein the second container is in fluid communication with the mixing structure.

5. The infant bottle-preparing device of claim 1, wherein the battery provides power to the motor, the pump, the warming structure, and the mixing structure.

6. The infant bottle-preparing device of claim 1, wherein the first container is comprised of a first threaded opening.

7. The infant bottle-preparing device of claim 1, wherein the first cap is comprised of a threaded cap.

8. The infant bottle-preparing device of claim 1, wherein the second container is comprised of a second threaded opening.

9. The infant bottle-preparing device of claim 1, wherein the second cap is comprised of a threaded cap.

10. The infant bottle-preparing device of claim 1, wherein the warming structure is comprised of a liquid heating element.

11. An infant bottle-preparing device comprising:
a first container comprised of a first cap;
a second container comprised of a second cap;
a mixing structure;
a warming structure;
a pump;
a motor;
a battery;
a threaded opening;
a trigger; and
a button.

12. The infant bottle-preparing device of claim 11, wherein the trigger activates the pump.

13. The infant bottle-preparing device of claim 11, wherein the threaded opening receives a threaded bottle opening of a bottle.

14. The infant bottle-preparing device of claim 11, wherein the bottle receives a threaded bottle cap.

15. The infant bottle-preparing device of claim 11, wherein the battery is comprised of a charging port.

16. The infant bottle-preparing device of claim 11, wherein a first door is positioned below the second container.

17. The infant bottle-preparing device of claim 11, wherein the first door is powered by the motor.

18. The infant bottle-preparing device of claim 11, wherein a second door is positioned below the mixing structure.

19. The infant bottle-preparing device of claim 11, wherein the second door is powered by the motor.

20. A method of using an infant bottle-preparing device, the method comprising the following steps:
providing an infant bottle-preparing device comprised of a body comprised of a handle comprised of a trigger, an interface, a mixing structure, a warming structure, a pump, a battery, a water container, and a formula container;
removing a cap from an infant bottle and securing the infant bottle within a bottle opening of the body;
using the interface to select an amount of water that is dispensed to and heated by the warming structure by pulling the trigger;
removing the infant bottle from the bottle opening after a bottle mixture created by the infant bottle-preparing device has been pumped into the infant bottle; and
attaching the cap to the infant bottle and serving the infant bottle with the bottle mixture to an infant.
